(19) United States
(12) Patent Application Publication
(10) Pub. No.: US 2012/0228459 A1
(43) Pub. Date: Sep. 13, 2012

(54) AUTOMATIC ROBOTIC HOLDER

(76) Inventor: Marc Chase Weinstein, Roslyn Heights, NY (US)

(21) Appl. No.: 13/415,345

(22) Filed: Mar. 8, 2012

Related U.S. Application Data
(60) Provisional application No. 61/450,230, filed on Mar. 8, 2011.

(51) Int. Cl. F16M 13/00

(52) U.S. Cl. 248/346.06; 901/28

(57) ABSTRACT

Embodiments of the present invention relate to a simple and low-cost device for providing a useful function to a user in a manner that is also entertaining, and more specifically, to an automatic robotic holder, such as a holder for business cards.

### BACKGROUND OF THE INVENTION

### Field of the Invention

Embodiments of the present invention generally relate to a simple and low-cost device for providing a useful function to a user in a manner that is also entertaining, and more specifically, to an automatic robotic holder.

### SUMMARY OF THE INVENTION

Embodiments of the present invention comprise a device for interacting with a user of the device, comprising a first portion which functions as a support component for the device, a second portion which functions as a user interactive component, such as a storage component, for the device, and a hinge mechanism which interconnects the first and second portions to one another in a hinged manner. In a closed operational state of the device the first and second portions are in a nested physical position with respect to each other so that the second portion cannot provide an interactive function to the user. However, upon activation of the hinge mechanism, an angular movement is automatically and without human interaction initiated between the first and second portions so that the first and second portions become progressively more displaced with respect to each other until the angular movement causes the device to reach an open operational state where the first and second portions are no longer nested together, and at which state the second portion provides at least one interactive function to the user of the device.

### BRIEF DESCRIPTION OF THE DRAWINGS

FIGS. 1A and 1B illustrate perspective views of one embodiment of an automatic robotic holder device constructed in a accordance with the principles of the invention, first in a closed position and next in an open position.

FIGS. 2A and 2B illustrate perspective views of another embodiment of an automatic robotic holder device constructed in a accordance with the principles of the invention, first in a closed position and next in an open position.

FIGS. 2C and 2D illustrate schematic side views of the embodiment of an automatic robotic holder device shown in FIGS. 2A and 2B.

FIGS. 3A and 3B illustrate perspective views of another embodiment of an automatic robotic holder device constructed in a accordance with the principles of the invention, first in a closed position and next in an open position.

FIGS. 3C and 3D illustrate schematic side views of the embodiment of an automatic robotic holder device shown in FIGS. 3A and 3B.

FIGS. 4A and B illustrate perspective views of an even further embodiment of an automatic robotic holder device constructed in a accordance with the principles of the invention, first in a closed position and next in an open position.

### DETAILED DESCRIPTION OF EMBODIMENTS

Embodiments of the present invention generally relate to a simple and low-cost device for providing a useful function to a user in a manner that is also entertaining, and more specifically, to an automatic robotic holder. The robotic device comprising a first portion which functions as a support component for the device, a second portion which functions as a user interactive component, such as a holding/storage component, for the device, and a hinge mechanism which interconnects the first and second portions to one another in a hinged manner. In a closed operational state of the device the first and second portions are in a nested physical position with respect to each other so that the second portion cannot provide an interactive function to the user, such as access to the holding/storage compartment. However, upon activation of the hinge mechanism, an angular movement is automatically and without human interaction initiated between the first and second portions so that the first and second portions become progressively more displaced with respect to each other until the angular movement causes the device to reach an open operational state where the first and second portions are no longer nested together, and at which state the second portion provides at the least one interactive function to the user of the device, such as access to the holding/storage compartment.

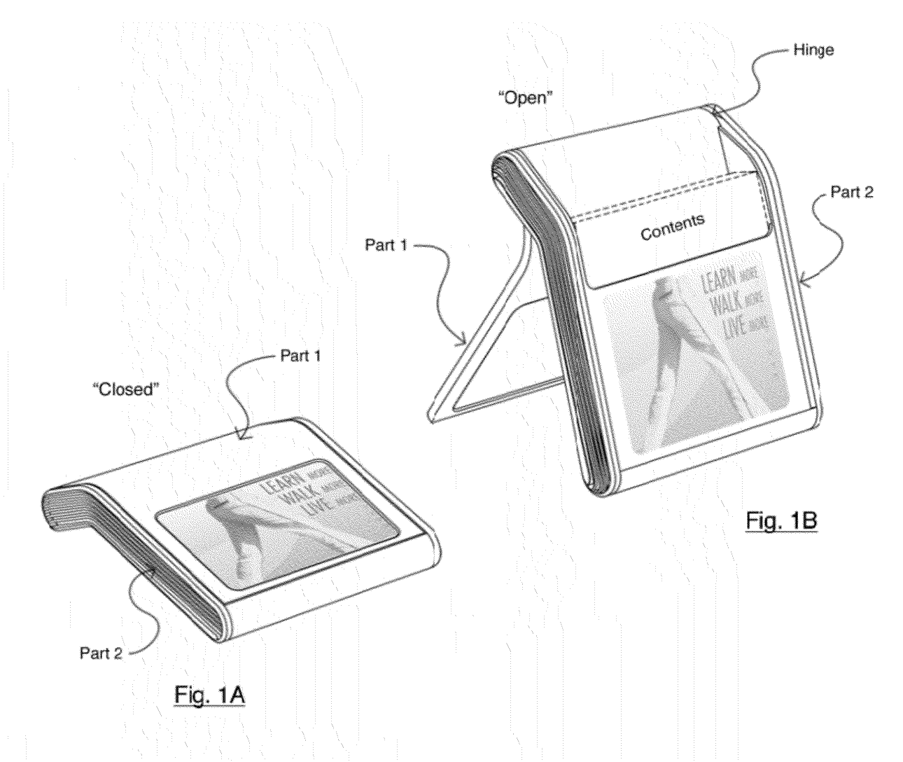

FIGS. 1A & B, 2A, B, C & D, 3A, B, C & D and 4A & B show different examples of one embodiment of a device constructed in a accordance with the principles of the invention, in this example, a robotic card holder. It can basically comprise components made of plastic and have an approximate outside dimension of 7″ by 8″ by 1.25″. But in other embodiments other materials and dimensions could be used.

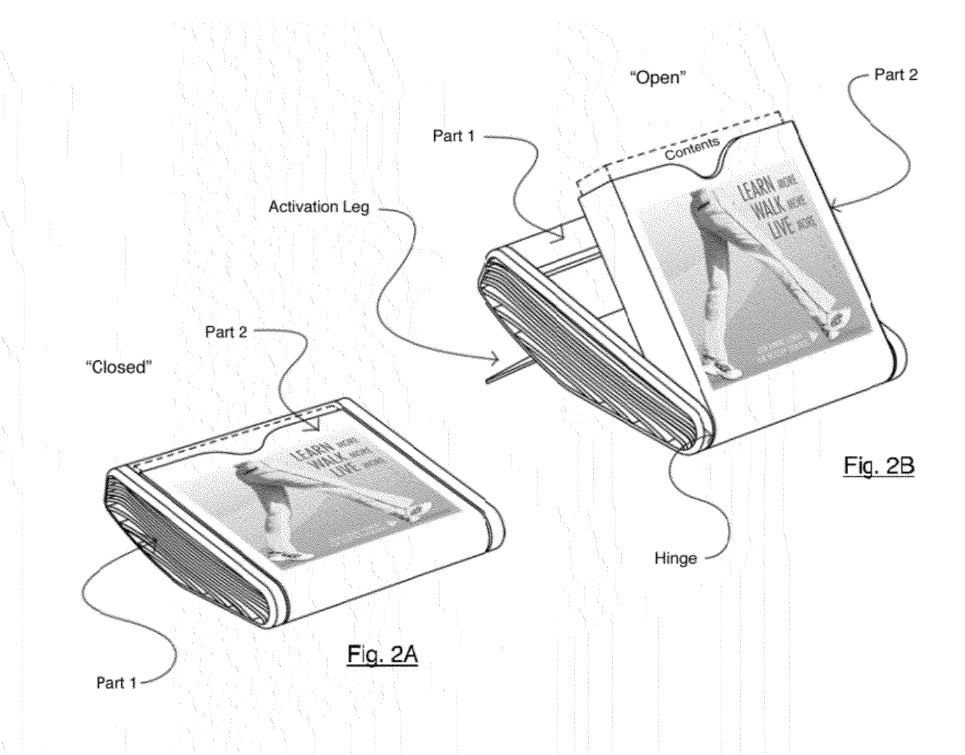

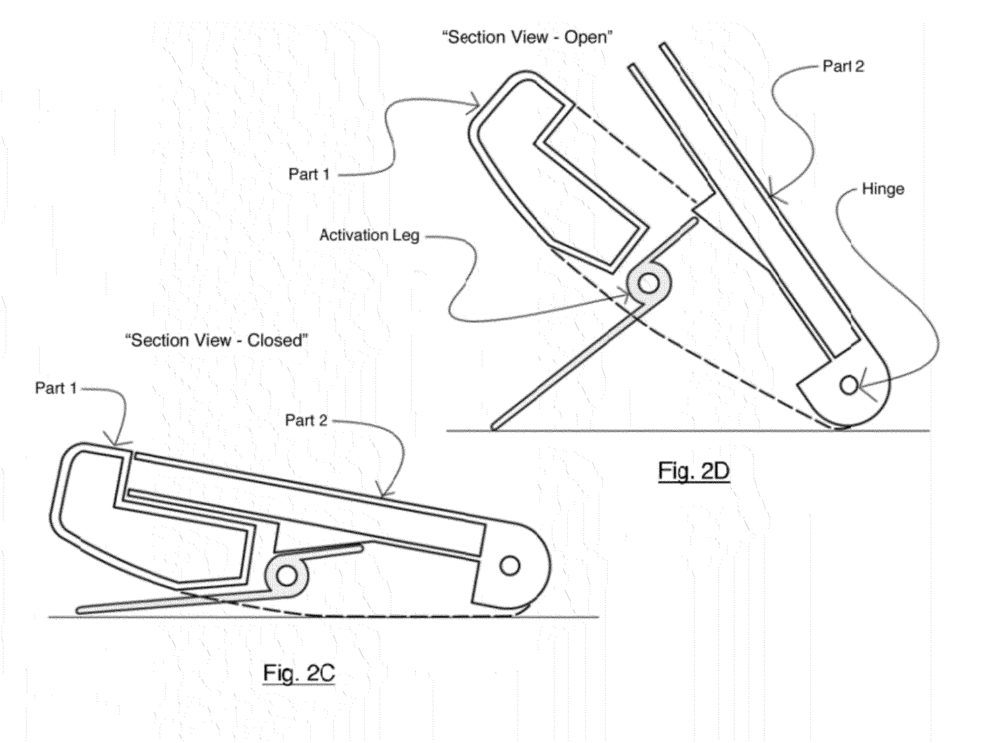

As shown in FIGS. 1A, 2A & C, 3A & C and 4A, portions 1 and 2 of the card holding device are initially positioned in a closed state and then change their position relative to one another so as to be in an open state upon activation of the hinge mechanism, such as shown in FIGS. 1B, 2B & D, 3B & D and 4B, by which unique advantages and functions are created by this movement. The hinge mechanism can allow a 270 degree movement, for example, but in other embodiments other degrees of movement could be used, between parts 1 and 2, as shown by comparing FIG. 1A to 1B. This 270 degree movement of the hinge results in part 2 moving from a horizontal position where it is resting on a surface, to one where it is elevated by an amount anywhere from 20 to about 70 degrees from the horizontal surface, for example, but in other embodiments other degrees of elevation could be used. This elevation of part 2 particularly results in the above-noted other interactive feature of the inventive device, namely an interesting image display that appears on part 2, as well as providing access to the holding/storage compartment. Details of how to make a spring loaded hinge mechanism are not provided since they are well known to those of ordinary skill in the art. For example, see U.S. Pat. No. 6,178,085, incorporated herein by reference, to see details of the use of a spring steel helical coil spring for interacting with a moving part, to cause a calculator to elevate from a horizontal position to a raised position of about 20 or more degrees.

Note, the FIG. 2 embodiment is different from a common feature found in the other Figures, in that the hinge activation mechanism is not co-located with the hinge mechanism. As shown more clearly in side section views show in FIGS. 2C and 2D, a spring-powered activation leg is positioned in a hinged manner on part 1 at a point intermediate opposed edges of part 1, so that upon activation of the leg, an inside portion of the leg contacts part 1 so as to cause said angular movement between parts 1 and 2, and an outside portion of the leg concurrently causes angular movement of part 1 with respect to a support surface upon which said device rests. The exact positioning of the leg on part 1 depends upon the precise characteristics of parts 1 and 2, as they relate to factors such as balance, stability and leverage.

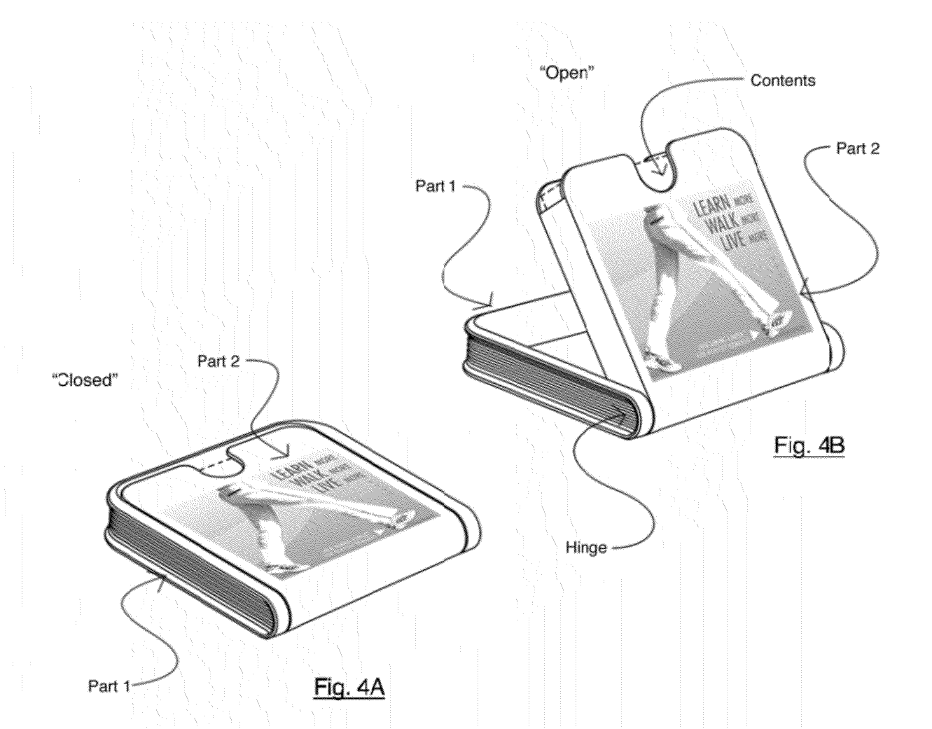

In one example the device in a closed position, that is the position where there is no user access to the holding/storage compartment, would be positioned in a “downward facing” or primarily horizontal position (as shown in FIGS. 1A-4A), and upon activation of the hinge mechanism a portion of the device which provides an interactive function to the user, that is, access to the storage/holding compartment, is elevated into a “standing” position. As noted above, this movement results in multiple separate functions happening simultaneously as a result of a single activation of the hinge mechanism:

Features and advantages of the invention are as follows:

1. Activation elevates part or the entire unit, (such elevation not being limited to any specific angular amount, such as completely vertical, etc.). The elevation of the part is anticipated to enable the part to provide a function to a user of the unit, such as better positioning of the part so as to allow easier user interaction, that is, access, with an article holding function of the part.

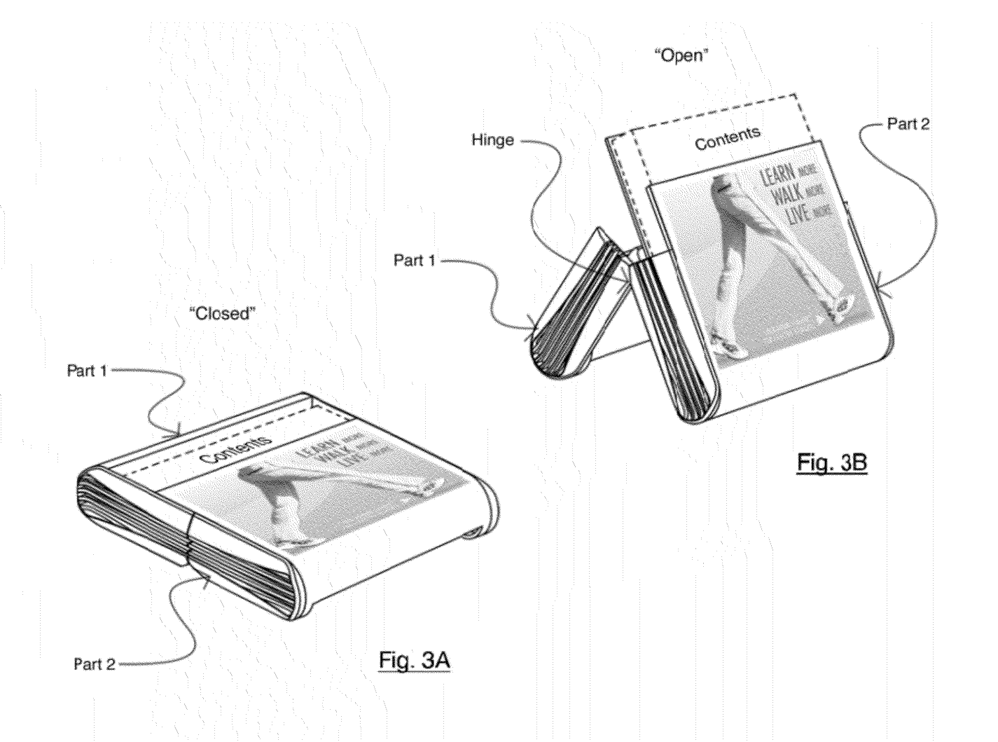

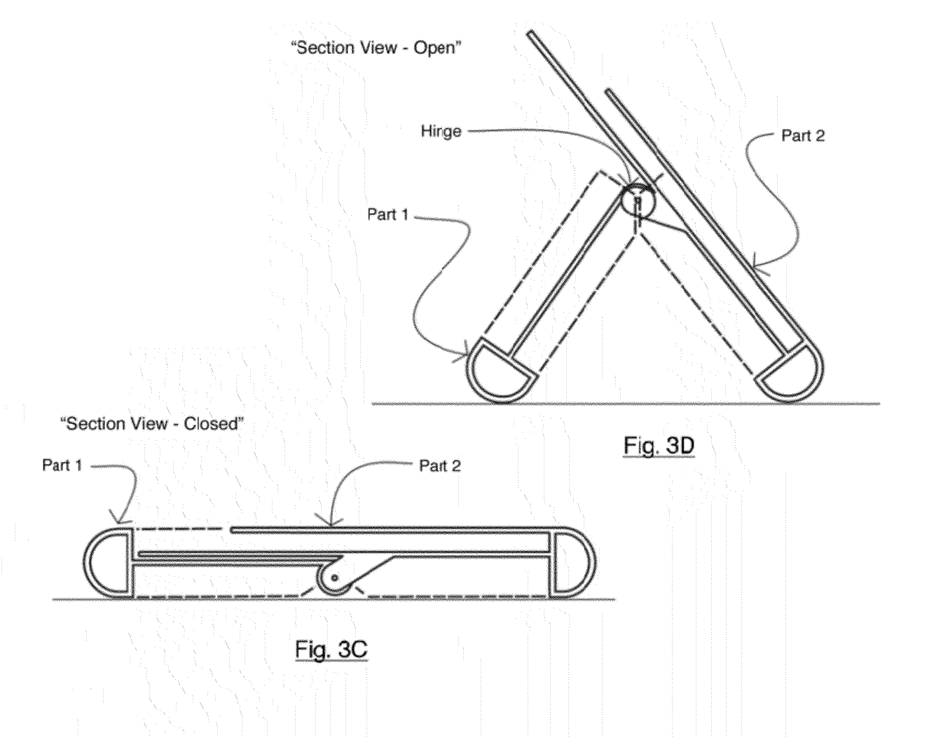

2. When the device is used as an article holder in accordance with some embodiments of the invention, it can allow access for removal of the contents, which in the closed, flat position is not possible to remove the contents of the holder. This can be accomplished either through the use of the hinge mechanism as part of a top or cover (part 1) over the article holder (part 2), as well as if the hinge is within the body of the unit (as shown by FIG. 3), thereby creating an additional angle to the body shape which provides access to the contents of part 2. These are only two options of many anticipated variations that are possible. With the latter creating an additional angle there can be a defined “holding area” which when in the open position allows more access to the contents.

3. Part 2 can provide a graphic area whether static art, graphics or physical relief shaped to become highlighted upon activation of the hinge mechanism, so that the angular movement between the parts 1 and 2 makes the graphic area both easier to see as well as more interesting to the user. This graphic area can be 2D art, or other type of visual technology, i.e.: video screen, LCD screen, hologram or lenticular lens printing among many options. With the lenticular lens, specifically, the action of the unit moving to a more vertical position allows the user to experience the lenticular image movement changes without having to move their own physical eye position as would be necessary in the case with a static positioning of a lenticular lens. For example, as shown in FIGS. 1A and 1B, the image of the persons legs can actually look like they are moving/walking, as a result of the angle of the lenticular changing as the hinge mechanism causes angular movement between the parts 1 and 2. In place of a lenticular lens, the graphic area could be a “stained glass light catcher” which when opened would allow light to more effectively pass there through and present a more pleasing effect to the user.

4. The overall change of positioning in and of itself creates a compelling event and adds interest to the entire unit.

5. The concept of the unit opening into a different shape also allows the savings of space when stored and reduced costs when shipping.

It is anticipated that there are other uses beyond a traditional holder for brochures or other articles, such as a toothbrush stand/holder, vitamin/pill case, collectible case, collectible sports/entertainment card holder, electronics holder/charger, picture frame, toy or other electronic device. In one embodiment of an electronic version of the function of the invention, speaker(s) would move from a closed or recessed position, to a position creating a more effectively enhanced audio presentation to the user.

The invention can be manufactured using a wide range of material including but not limited to paper, plastic, and metal.

While the foregoing is directed to embodiments of the present invention, other and further embodiments of the invention may be devised without departing from the basic scope thereof, and the scope thereof is determined by the claims that follow.

1. A robotic device, comprising:
a first portion which functions as a support component for the device;
a second portion which functions as a holding compartment for the device; and
a hinge mechanism which interconnects the first and second portions to one another in a hinged manner, such that in a closed operational state of the device the first and second portions are in a nested physical position with respect to each other so that the second portion cannot provide access by a user to the holding compartment of the robotic device, and that upon activation of the hinge mechanism, an angular movement is automatically and without human interaction initiated between the first and second portions so that the first and second portions become progressively more displaced with respect to each other, until the angular movement causes the device to reach an open operational state where the first and second portions are no longer nested together, and at which state the second portion provides access by the user to the holding compartment of the device.

2. The robotic device of claim 1, wherein a spring-activated hinge mechanism joins together a corresponding edge of each of the first and second portions.

3. The robotic device of claim 2, wherein the spring-activated hinge mechanism mechanism is located between opposed edges of one of the first and second portions.

4. The robotic device of claim 1, wherein a passive hinge mechanism joins together a corresponding edge of each of the first and second portions and a spring-activated leg is provided at a point between opposed edges of one of the first and second portions so as to cause said automatic and without human interaction angular movement between the first and second portions.
